(19) United States
(12) Patent Application Publication
(10) Pub. No.: US 2015/0225428 A1
(43) Pub. Date: Aug. 13, 2015

(54) TETRAMETHYLSTANNOXY COMPOUNDS

(71) Applicants: Rohm and Haas Company, Philadelphia, PA (US); Dow Global Technologies LLC, Midland, MI (US); Dow Europe GmbH, Horgen (CH)

(72) Inventors: Manfred Etzelstorfer, Buchs (CH); Renjie Ge, Dusseldorf (DE); Matthias Kohl, Dusseldorf (DE); Cord Manegold, Moos (DE); Manfred Proebster, Dusseldorf (DE)

(21) Appl. No.: 14/423,488

(22) PCT Filed: Aug. 21, 2013
(86) PCT No.: PCT/EP2013/067377

§ 371 Date: Feb. 24, 2015

Related U.S. Application Data
(60) Provisional application No. 61/731,165, filed on Nov. 29, 2012.

(30) Foreign Application Priority Data
Aug. 24, 2012 (EP) 12181689.6

(51) Int. Cl. C07F 7/22; B01J 31/12

(52) U.S. Cl. CPC C07F 7/2256; B01J 31/12; B01J 2231/14

(57) ABSTRACT

A compound having formula (I)

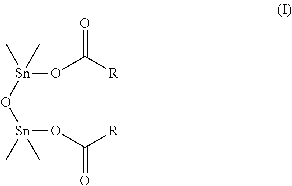

where R is C₉-C₁₁ alkyl, C₉-C₁₁ alkenyl, C₁₇ alkyl or C₁₇ alkenyl.

This invention relates to new tin compounds which are useful as catalysts for a variety of reactions.

Tetraalkylstannoxy compounds have been disclosed in the prior art. For example, Eur. Pat. No. 446,171 discloses tetraalkylstannoxy compounds having a structure referred to therein as “(D)” as shown below:

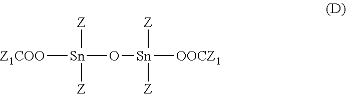

where Z is C₁-C₂₀ alkyl and Z₁ is hydrogen, C₁-C₂₀ alkyl, C₃⁻C₂₀ alkenyl, C₅-C₈ cycloalkyl, phenyl, C₇-C₁₈ alkylphenyl or C₇-C₉ phenylalkyl. However, this reference does not disclose or suggest the compounds claimed herein. The problem addressed by this invention is to find additional useful tin catalysts.

### STATEMENT OF INVENTION

The present invention provides a compound having formula (I)

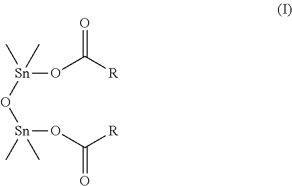

where R is C₉-C₁₁ alkyl, C₉-C₁₁ alkenyl, C₁₇ alkyl or C₁₇ alkenyl.

### DETAILED DESCRIPTION

Percentages are weight percentages (wt %) and temperatures are in ° C., unless specified otherwise. An “alkyl” group is a saturated hydrocarbyl group having from one to twenty-two carbon atoms in a linear or branched arrangement. An “alkenyl” group is an alkyl group having at least one carbon-carbon double bond. Preferably, alkenyl groups are linear. Preferably, alkenyl groups contain no more than three carbon-carbon double bonds, preferably one or two carbon-carbon double bonds, preferably only one carbon-carbon double bond. Preferably, carbon-carbon double bonds in alkenyl groups are in the cis (Z) configuration.

Preferably, R is C₉-C₁₁ alkyl, C₁₇ alkyl or C₁₇ alkenyl; preferably C₉-C₁₁ alkyl or C₁₇ alkenyl; preferably C₉ alkyl, C₁₁ alkyl, C₁₇ alkyl or C₁₇ alkenyl; preferably C₉ alkyl, C₁₁ alkyl or C₁₇ alkenyl; preferably C₉ branched alkyl, C₁₁ alkyl or C₁₇ alkenyl; preferably C₉ branched alkyl, C₁₁ alkyl or C₁₇ alkenyl having only one double bond; preferably 1-ethyl-1,4-dimethylpentyl (alkyl group of neodecanoic acid), n-undecyl (alkyl group of lauric acid) or cis-8-heptadecenyl (alkyl group of oleic acid). Other suitable choices for R include 15-methylhexadecyl (alkyl group of isostearic acid), 3-heptyl (alkyl group of 2-ethylhexanoic acid) and tridecyl (alkyl group of myristic acid (tetradecanoic acid)).

The compounds of this invention may be prepared by contacting dimethyl tin dioxide with a fatty acid and heating, followed by removal of water to produce the dimeric stannoxy compound.

The compounds of this invention are useful for production of polyurethanes from isocyanate and polyol components, especially for production of polyurethane foams from polyisocyanate and polyol components.

### EXAMPLES

### Example 1

### Tetramethylstannoxy bis-(C₁₂-C₁₈ Carboxylate)

658.8 g Dimethyltin oxide (DMTO) (4 mol) and 801.2 g (3.6-3.8 mol) of Coconut fatty acid (RADIACID 0600, Oleon) (1 mol) were mixed in a 1 L rotary evaporator flask to form a slurry. This slurry was heated up on the rotary evaporator to approx. 80° C. and kept for 2 hours at this temperature.

Afterwards the reaction water was removed by distillation under vacuum at a temperature up to 110° C./10 mbar. The theoretical amount of water was removed (36.6 g, 2.03 mol). Finally 1% of Celite (a filter aid) was added and the product was filtered.

Yield: 342.6 g catalyst, (95.3% theor.). ¹³C NMR (CDCl₃): δ6.32, 8.74, 14.05, 22.64, 25.66, 29.33, 29.50, 29.58, 31.88, 36.26, 180.19 ppm. ¹H NMR (CDCl₃): δ0.76-1.55 (m, 25 H); 2.13-2.20 (t, 2H). There is only one set of signals for proton and carbon NMR because the molecule is symmetrical. ¹¹⁹Sn NMR (CDCl₃): δ:−186.0 and −207.3. Tin NMR showed 2 distinct peaks because RCOOSnMe₂—O—SnMe₂OCOR forms dimers with exo and endo Sn symmetries, explaining the two different chemical shifts. The Sn is sp³d hybridized, which is trigonal bipyramidal, allowing for the ladder structure. This behavior is known for di-tin compounds: 119Sn-NMR spectroscopic study of the 1,3-dichloro- and1,3-diacetoxytetra-n-butyldistannoxane binary system. Journal of Organometallic (2001), 620, 296-302. ESI Mass spectroscopy (300V): C₁₆H₃₅O₃Sn₂⁺[515.06]. This confirms the presence of Sn—O—Sn linkage in the molecule.

The material was also analyzed by Atmospheric Solid Analyses Probe-Mass Spectrometry (ASAP-MS). The analysis was carried out on the sample without any dissolution. The samples were placed onto one end of the capillary and directly introduced into the ionization source. The fragmentor voltage utilized was 50V. Based on the ASAP-MS analyses, molecular ions were generated for the samples. The molecular ions generated were due to the hydride abstraction from the parent complex. The hydride extraction is likely on the fatty acid chain group during ionization. ASAP Mass Spectroscopy (50V): C₂₈H₅₇O₅Sn₂⁺[713.224]. This confirms the presence of the desired material.

Equation shown below for lauric acid (Coconut fatty acid used in the preparation is 52-59% dilaurate, <1.5% bis-C₆-C₁₀ carboxylate, 19-23% bis-C₁₄ carboxylate, 8-12% bis-C₁₅ carboxylate, 5-10% bis-mono-unsaturated C₁₈ carboxylate and <3% bis-di-unsaturated C₁₈ carboxylate)

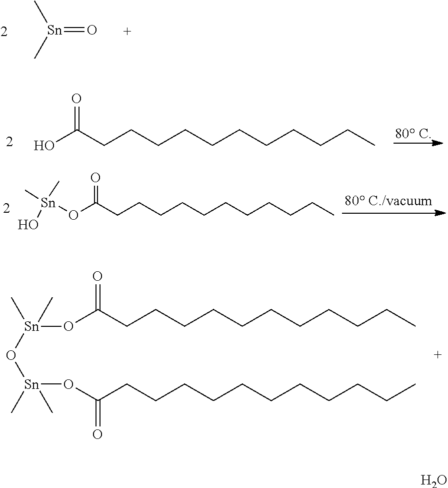

### Example 2

### Tetramethylstannoxy Dioleate

164.7 g DMTO (1 mol) and 282.5 g oleic acid (1 mol) were allowed to react using the same procedure as in Ex. 1. The theoretical amount of water was removed (7.9 g, 0.44 mol).

Yield: 426.8 g catalyst, (95.4% theor.). Liquid, solidification point −10° C. ¹³C NMR (CDCl₃): δ6.27, 8.69, 14.00, 22.52, 25.57, 27.08, 29.06, 29.21, 29.43, 29.63, 31.81, 35.78, 129.61, 129.82, 180.84 ppm. ¹H NMR (CDCl₃): δ0.69-2.20 (m, 37 H); 5.32-5.37 (t, 2H). ¹¹⁹Sn NMR (CDCl₃): δ: −185 and −205. ESI Mass spectroscopy (300V): C₂₂H₄₅O₃Sn₂⁺ [597.14]. This confirms the presence of Sn—O—Sn linkage in the molecule.

The material was also analyzed by Atmospheric Solid Analyses Probe-Mass Spectrometry (ASAP-MS). The analysis was carried out on the sample without any dissolution. The samples were placed onto one end of the capillary and directly introduced into the ionization source. The fragmentor voltage utilized was 50V. Based on the ASAP-MS analyses of Metatin catalyst 1282, molecular ions were generated for the samples. The molecular ions generated were due to the hydride abstraction from the parent complex. The hydride extraction is likely on the fatty acid chain group during ionization. ASAP Mass Spectroscopy (50V): C₄₀H₇₇O₅Sn₂⁺[877.381]. This confirms the presence of the desired material.

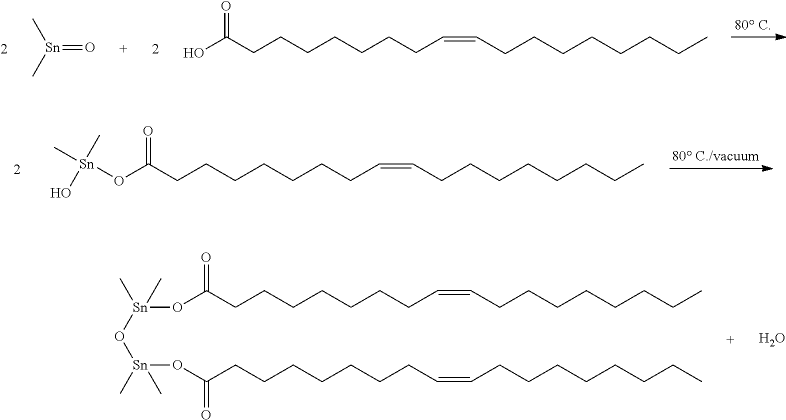

### Example 3

### Tetramethylstannoxy Dilaurate

164.7 g DMTO (1 mol) and 200.3 g Lauric acid 99% (1 mol) were allowed to react using the same procedure as in Ex. 1. The theoretical amount of water was removed (8.9 g, 0.49 mol).

Solid, mp 60° C. ¹³C NMR (CDCl₃): δ6.38, 8.74, 14.08, 22.66, 25.65, 29.34, 29.51, 29.59, 31.89, 36.21, 180.32 ppm. ¹H NMR (CDCl₃): 30.76-1.57 (m, 25 H); 2.17 (br, 2H). ESI Mass spectroscopy (300V): C₁₆H₃₅O₃Sn₂⁺[515.061]. This confirms the presence of Sn—O—Sn linkage in the molecule.

### Example 4

### Tetramethlystannoxy Dineodecanoate

666.4 g DMTO (4 mol) and 698 g Neodecanoic acid (4 mol) (mixture of isomers: 2,2,3,5-tetramethylhexanoic acid; 2,4-dimethyl-2-isopropylpentanoic acid; 2,5-dimethyl-2-ethylhexanoic acid; 2,2-dimethyloctanoic acid; 2,2-diethylhexanoic acid) were allowed to react using the same procedure as in Ex. 1. The theoretical amount of water was removed (37.3 g, 2.07 mol).

Highly viscous liquid. NMR signals were generally consistent with structure, although the number of isomeric alkyl groups renders complete peak assignment impossible.

Equation for 2,5-dimethyl-2-ethylhexanoic acid

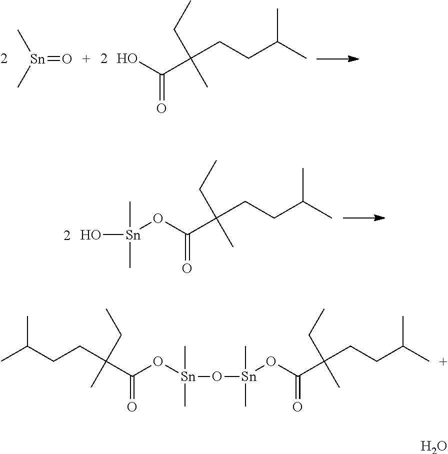

### Catalyst Testing

The following materials are principally used:
VORALAST™ GE 128 An isocyanate polyether prepolymer based on MDI and polyether diols and triols having an average NCO content of 20.8 wt % (available from The Dow Chemical Company).
VORANOL™ EP 1900 A polyoxypropylene-polyoxyethylene polyol, which is ethylene oxide-terminated, having a theoretical OH functionality of 2, an average molecular weight of about 4000, and a nominal average hydroxyl number of 28 mg KOH/g (available from The Dow Chemical Company)
VORANOL™ CP 6001 A glycerol initiated polyoxypropylene- polyoxyethylene polyol, which is ethylene oxide-terminated, having a theoretical OH functionality of 3, an average molecular weight of about 6000, and a nominal average hydroxyl number of 26-29 mg KOH/g (available from The Dow Chemical Company)
SPECFLEX™ NC 138 A glycerol initiated polyoxypropylene -polyoxyethylene polyol, having a theoretical OH functionality of 3, an average molecular weight of about 5700, and a nominal average hydroxyl number of 29.5 mg KOH/g (available from The Dow Chemical Company).
NIAX™ L-6900 A stabilizer that is a non-hydrolizable silicone copolymer having an average hydroxyl number of 49 mg KOH/g (available from Momentive Performance Materials Inc).
DABCO® 33 LB A catalyst that is a solution of 33 wt % triethylendiamine (TEDA) diluted in 67 wt % of 1,4-butanediol and has a nominal average hydroxyl number of 821 mg KOH/g (available from Air Products & Chemicals, Inc.).
POLYCAT® 77 A catalyst that is a bis(dimethylaminopropyl)methylamine based solution having a specific gravity of 0.85 at 25° C. (g/cm³) and a viscosity of 3 mPa*s at 25° C. (available from Air Products & Chemicals Inc.).
POLYCAT® SA-1/10 A catalyst that is 1,8-diazobicyclol[5,4,0]unde-7-cene (DBU) based solution, having a nominal average hydroxyl number of 83.5 mg KOH/g (available from Air Products & Chemicals Inc.).
HFA 134a A blowing agent that is 1,1,1,2-tetrafluoroethane.
TEGOSTAB™ B 2114 A silicon-based surfactant (available from Evonik Industries).
FOMREZ™ UL 38 A dioctyltin carboxylate catalyst (available from Momentive Performance Materials Inc).
METATIN™ 1213 A dimethyltin-di-2-ethylexyl thioglycolate catalyst (available from Acima Speciality Chemicals, Inc., a subsidiary of The Dow Chemical Company).
METATIN™ 1215 A dimethyltin didodecylmercaptan catalyst (available from Acima Speciality Chemicals, Inc., a subsidiary of The Dow Chemical Company).

The following formulated polyols, according to the exemplary embodiments of Examples 5 and 6, are each individually reacted with the VORALAST™ GE 128 isocyanate component to form polyurethane foams. In particular, 100 parts by weight of each of the formulated polyols of Examples 5 and 6 is reacted with 54 parts by weight of the VORALAST™ GE 128 isocyanate component. The formulated polyols of Examples 5 and 6 include a catalyst component that has a tetraalkylstannoxy based catalyst (e.g., instead of a dioctyltin based catalyst such as FOMREZ UL 38). As shown in Table 1, below, Examples 5 and 6 include 0.01 wt % and 0.02 wt %, respectively, of tetramethylstannoxy dineodecanoate in the catalyst component.

TABLE 1

| | Example 5 | Example 6 |
|---|---|---|
| Raw Material | Amount, wt % | Amount, wt % |
| VORANOL EP 1900 | 64.73 | 64.73 |
| 1,4-butanediol | 8.6 | 8.6 |
| VORANOL CP 6001 | 17.0 | 17.0 |
| SPECFLEX NC 138 | 4.60 | 4.60 |
| NIAX L-6900 | 0.35 | 0.35 |
| DABCO 33 LB | 1.30 | 1.30 |
| POLYCAT 77 | 0.10 | 0.10 |
| HFA 134a | 2.50 | 2.50 |
| POLYCAT SA-1/10 | 0.10 | 0.10 |
| TEGOSTAB B 2114 | 0.58 | 0.58 |
| Tetramethylstannoxy dineodecanoate | 0.01 | 0.02 |
| (DOT free catalyst) | | |
| Water | 0.13 | 0.12 |

A formulated polyol for Example 7 replaces the 0.02 wt % of tetramethylstannoxy dineodecanoate in Example 6 with 0.02 wt % of FOMREZ™ UL 38. The formulated polyol for Example 7 is reacted with the VORALAST™ GE 128 isocyanate component to form a polyurethane foam. In particular, 100 parts by weight of the formulated polyol for Example 7 is reacted with 54 parts by weight of the VORALAST™ GE 128 isocyanate component.

Formulated polyols for Comparative Examples 8 and 9 replace the 0.01 wt % and the 0.02 wt % of tetramethylstannoxy dineodecanoate in Examples 5 and 6, with 0.01 wt % and the 0.02 wt % of METATIN™ 1213 catalyst, respectively. Formulated polyols for Comparative Examples 10 and 11 replace the 0.01 wt % and the 0.02 wt % of tetramethylstannoxy dineodecanoate in Examples 5 and 6, with 0.01 wt % and the 0.02 wt % of METATIN™ 1215 catalyst, respectively. The formulated polyols for Comparative Examples 8-11 are each individually reacted with the VORALAST™ GE 128 isocyanate component to form polyurethane foams. In particular, 100 parts by weight of each of the formulated polyols of Examples 8-11 is reacted with 54 parts by weight of the VORALAST™ GE 128 isocyanate component.

Samples of the resultant reaction products of Examples 5-11 are each prepared (test plates are formed using molds and each test plate has a size of 200×200×10 mm) and the samples are evaluated with respect to reactivity and physical-mechanical properties, as shown below in Table 2. In particular, cream time (ASTM D7487-8), gel time (ASTM D2471), pinch time (ASTM D7487-8), imprintability (ASTM D7487-8), fine root density (ISO 845), minimum demolding time (using the Dog Ear Test with mold temperature at 50° C.), tear strength (DIN 53543), tensile strength (DIN 53543), elongation (DIN 53543), flex fatigue (DIN 53543, “De Mattia” flexing machine), and hardness (according to ISO 868) are measured for each of Examples 5-11.

TABLE 2

| | | |
|---|---|---|
| Ex. 5 | Ex. 6 | Ex. 7 |

| | | | | | |
|---|---|---|---|---|---|
| Exemplary | Ref. | Ex. 8 | Ex. 9 | Ex. 10 | Ex. 11 |

| | | |
|---|---|---|
| Embodiments | Ex. | Comparative Examples |

Reactivity

| | | | | | | | |
|---|---|---|---|---|---|---|---|
| Cream Time (s) | 6/7 | 5/6 | 7 | 7/8 | 7 | 6/7 | 5/6 |
| Gel time (s) | 14 | 13 | 15 | 18 | 17 | 17 | 13 |
| Pinch time (s) | 29 | 26 | 25 | 34 | 30 | 31 | 27 |
| Imprintability (s) | 33/34 | 31 | 30 | 38 | 35 | 34 | 31/32 |
| Fine root density (g/l) | 235 | 226 | 230 | 226 | 232 | 227 | 224 |
| Minimum demolding time | 235 | 210 | 210 | >270 | >270 | >270 | >270 |

Physical-Mechanical properties

| | | | | | | | |
|---|---|---|---|---|---|---|---|
| Tear (N/mm) | 5.3 | 4.7 | 5.1 | 5.1 | 5.2 | 5.0 | 5.5 |
| Tensile (N/mm\hat{ }2) | 4.1 | 4.3 | 4.2 | 3.6 | 4.2 | 4.1 | 4.1 |
| Elongation (%) | 434 | 453 | 413 | 413 | 450 | 429 | 454 |
| Flex fatigue (kcycles) | 20 | 20-30 | 20-30 | 10 | 10 | 10 | 20 |
| Hardness (ShA) | 55 | 54 | 55 | 54 | 54 | 54 | 55 |

The replacement of dioctyltin based catalysts (Example 7) with dimethyltin dicarboxylate based catalysts or with sulfur-containing diamethyltin based catalysts (Examples 8-11) in polyurethane systems demonstrate increased flex fatigue and longer minimum demolding times for the final polyurethane foam, which can lead to productivity issues for final end users. However, according to embodiments, the use of tetraalkylstannoxy based catalyst such as tetramethylstannoxy dineodecanoate (Examples 5 and 6) provides both decreased flex fatigue and shorter minimum demolding times relative to the dimethyltin dicarboxylate based catalysts and the sulfur-containing diamethyltin based catalysts. Accordingly, the tetraalkylstannoxy based catalyst is demonstrated as a more viable replacement for di-substituted organotin compounds such as the dioctyltin based catalysts.

1. A compound having formula (I) 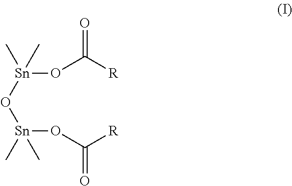
where R is C₉-C₁₁ alkyl, C₉-C₁₁ alkenyl, C₁₇ alkyl or C₁₇ alkenyl.

2. The compound of claim 1 in which R is C₉-C₁₁ alkyl, C₁₇ alkyl or C₁₇ alkenyl.

3. The compound of claim 2 in which R is C₉ alkyl, C₁₁ alkyl or C₁₇ alkenyl.

4. The compound of claim 3 in which R is C₉ branched alkyl, C₁₁ alkyl or C₁₇ alkenyl having only one double bond.

5. The compound of claim 4 in which R is 1-ethyl-1,4-dimethylpentyl, n-undecyl or cis-8-heptadecenyl.

6. Tetramethylstannoxy dioleate.

7. Tetramethlystannoxy dineodecanoate.

8. Tetramethlystannoxy dilaurate.

9. Tetramethylstannoxy diisostearate.
